(19) United States
(12) Patent Application Publication
(10) Pub. No.: US 2008/0217424 A1
(43) Pub. Date: Sep. 11, 2008

(54) Wall hanging music fountain

(76) Inventor: Lincong Yang, Wneling City (CN)

Correspondence Address: SUITER SWANTZ PC LLO, 14301 FNB PARKWAY, SUITE 220, OMAHA, NE, 68154, US

(21) Appl. No.: 11/901,351

(22) Filed: Sep. 17, 2007

(30) Foreign Application Priority Data
Mar. 7, 2007 (CN) 200720107007.9

(51) Int. Cl. B05B 17/00

(52) U.S. Cl. 239/18

(57) ABSTRACT

A wall hanging music fountain comprises a mirror frame comprising a plurality of side frames, a controller, a water flow distributor, a LED wire cavity, and a water distribution cavity. A water tank is disposed at a lower side frame of one of the plurality of side frames and an upper cover is disposed on an upper side frame of the plurality of side frames. A plurality of LED holes are disposed on an upper region of the LED wire cavity, each of the plurality of LED holes being connected with a LED. A plurality of nozzle holes are disposed on the water distribution cavity, each of the plurality of nozzle holes being connected with a water flow nozzle.

### CROSS-REFERENCES TO RELATED APPLICATIONS

This application claims priority to Chinese Patent Application No. 200720107007.9, filed on Mar. 7, 2007. Chinese Patent Application No. 200720107007.9 is incorporated herein by reference.

### TECHNICAL FIELD

The present invention relates to a fountain device, moor particularly to a kind of wall-hanging fountain for indoor decoration and appreciation.

### BACKGROUND

Mini-fountains provide a visually attractive and soothing environment for a user. At present, the mini fountains in the prior art usually are of standing or desk types, which have the common insufficiency is that they will occupy a certain area in the room. Consequently, a wall-hanging music fountain is needed.

### SUMMARY OF THE INVENTION

Accordingly, the present invention provides a sealed-type wall hanging music fountain. The wall hanging music fountain comprises a mirror frame, a controller, a water flow distributor. The mirror frame further comprises a water pump. The mirror frame also comprises a plurality of side frames disposed within the mirror frame. The plurality of side frames comprise a water tank disposed in a lower part of one of the plurality of side frames and an upper cover is disposed on an upper part of one of the plurality of side frames. An image is disposed within the perimeter of the mirror frame. The water flow distributor is an integrated cavity, including a LED wire cavity and an adjacent water distribution cavity. A plurality of LED holes may be disposed on the upper part of the LED wire cavity. Each LED hole is connected with the LED. A plurality of nozzle holes may be disposed on the water distribution cavity, each nozzle hole being connected with a water flow nozzle.

### BRIEF DESCRIPTION OF THE DRAWINGS

The numerous advantages of the present invention may be better understood by those skilled in the art by reference to the accompanying figures in which:

FIG. 1 is the structural illustration view of the part section according to the Present invention;

FIG. 2 is the structural illustration view of the side part section in FIG. 1; and

FIG. 3 is the planform of the water flow distributor.

### DETAILED DESCRIPTION OF THE INVENTION

Reference will now be made in detail to the presently preferred embodiments of the invention, examples of which are illustrated in the accompanying drawings.

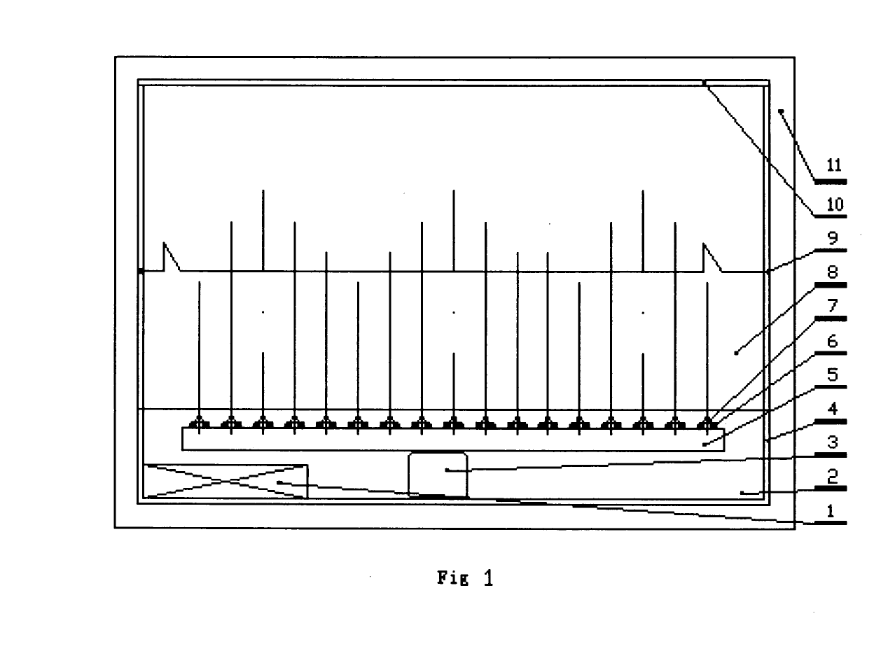

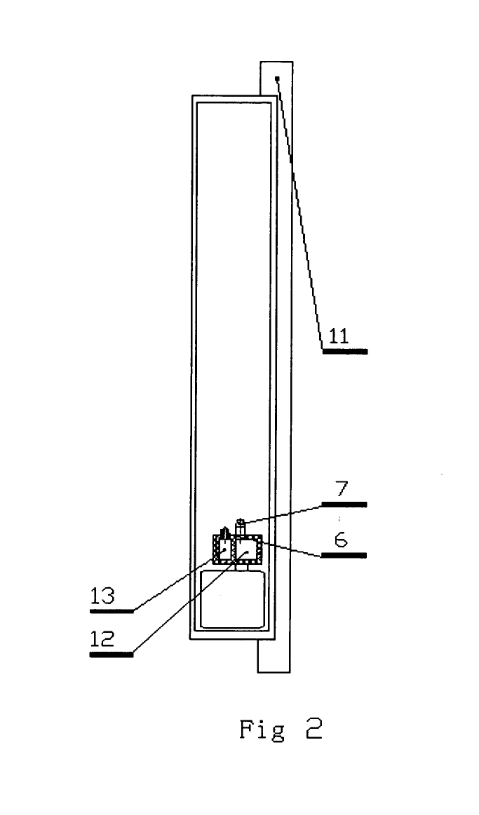

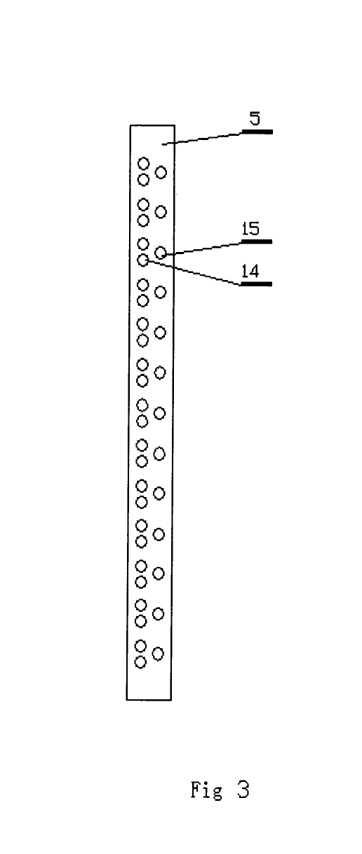

Referring to FIGS. 1-3, a wall hanging music fountain 100 according to exemplary embodiments of the present invention is shown. The wall hanging music fountain 100 comprises a mirror frame 11, a controller 1, and a water flow distributor 5. The mirror frame 11 further comprises a water pump 3. The mirror frame 11 also comprises a plurality of side frames 9 disposed within the mirror frame 11. The plurality of side frames 9 comprise a water tank 4 disposed in a lower part of one of the plurality of side frames 9 and an upper cover 10 is disposed on an upper part of one of the plurality of side frames 9. The water flow distributor 5 is an integrated cavity. Water flow distributor 5 may comprise a LED wire cavity 12 and an adjacent water distribution cavity. A plurality of LED holes 14 may be disposed on the upper part of the LED wire cavity. Each LED hole is connected with a LED. A plurality of nozzle holes 15 may be disposed on the water distribution cavity, each nozzle hole being connected with a water flow nozzle.

An image is disposed within the perimeter of the mirror frame 11. Preferably, the image or picture may be divided into a front picture 2 and a rear picture 8. The front picture 2 is mounted, via an adhesive, magnet, or other mounting mechanism, on the lower part of the front mirror frame 11. The front picture 2 may prevent the water flow distributor 5 and small water pump 3 and water tank 4 from being viewed by a viewer. The front picture 2 mounting position may also prevent a viewer from viewing the LEDs 6 and nozzles installed on the upper part of the water flow distributor 5. The rear picture 8 is mounted, via an adhesive, magnet, or other mounting mechanism, on the rear internal wall inside the mirror frame 11. The front picture 2 in the front of the mirror frame 11 and the rear picture on the internal wall in the mirror frame 11 comprise the complete picture. For example, an integral image may be formed from the overlapping sections between the front picture 2 and the rear picture 8.

The wall-hanging music fountain 100 may be directly mounted onto the wall by the use of the mirror frame 11, without occupying a horizontal surface. A cover 10 may be disposed on the front of mirror frame 11. Cover 10 may be a transparent glass, plastic or like clear durable material, and may be mounted on a front surface of the wall hanging music fountain 100, within the perimeter of the mirror frame 11. Cover 10 may form a closed mirror frame, suitable for substantially preventing water from the music fountain 100 from splashing to the outside when the music fountain 100 is on.

The controller 1 may be a program controller or a music controller, suitable for controlling the music fountain 100 water movements such as jumping in coordination with the rhythm of a segment of music, up and down, and the like. Controller 1 may also control music fountain height, and may modify music fountain height as desired by a user, automatically at designated times, or some combination of the two. The water flow distributor 5 may be disposed on an internal wall substantially inside in the mirror frame 11. The LED wire cavity 12 and the water distribution cavity 13 may be separated by a baffle disposed substantially between the LED wire cavity 12 and the water distribution cavity 13 in a substantially central region of the LED wire cavity 12 and the water distribution cavity. The bottom region of the LED wire cavity 12 and the bottom region of the water distribution cavity 13 may be coupled. A plurality of LED holes 14 may be disposed within the LED wire cavity 12. For example, the plurality of LED holes 14 may be disposed two LED holes 14 across, and all LED holes 14 may be aligned along the same vertical axis and evenly distributed across a surface of the LED wire cavity.

A plurality of nozzle holes 15 may be disposed on the water distribution cavity. The plurality of nozzle holes 15 may be positioned along a straight line, and in even distribution. One pair of LED holes 14 corresponds to one nozzle hole 15. The position of each nozzle hole 15 may be the vertical midline of the line connecting a pair of the LED holes 14, and an LED 6 is installed within the LED hole 14. LED may be installed electronically via conventional methods to provide a lighted LED when connected to an electricity supply. LEDs 6 may be various colors, including, but not limited to red, yellow, green and blue or some combination of red, yellow, green and blue.

A plurality of nozzles 7 may be installed within the nozzle holes 15 accordingly. The nozzles 7 may be installed at different angles with respect to the nozzle holes 15, which can be vertically position, horizontally positioned or inclined. Both the plurality of LEDs 6 and the plurality of nozzles 7 may be under the control of the music controller or the program controller. Via the controller, wall hanging music fountain 100 may generate water columns of varying heights at varying time intervals. Specifically, when the LED 6 and the nozzle 7 are under the control of the program controller 1, the water sprayed from the nozzle 7 forms water columns in different heights at different time intervals. The water columns reflect at least one LED 6, producing colorful water columns, and set off by the image within the mirror frame 11.

Preferably, the mirror frame 11 is sealed. Thus, substantially all water sprinkled from the nozzles may be circulated within the mirror frame 1, and may not be splashed or spill to the outside.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed:

1. A wall hanging music fountain comprising:
a mirror frame comprising a plurality of side frames;
a controller;
a water flow distributor;
a LED wire cavity; and
a water distribution cavity,
wherein a water tank is disposed at a lower side frame of one of the plurality of side frames and an upper cover is disposed on an upper side frame of the plurality of side frames, a plurality of LED holes are disposed on an upper region of the LED wire cavity, each of the plurality of LED holes being connected with a LED, and a plurality of nozzle holes are disposed on the water distribution cavity, each of the plurality of nozzle holes being connected with a water flow nozzle.

2. The wall hanging music fountain according to the claim 1, wherein the water tank further comprises a small water pump.

3. The wall hanging music fountain according to claim 2, wherein a bottom region of the small water pump is coupled with a bottom region of the water flow distributor.

4. The wall hanging music fountain according to the claim 1, further comprising an image disposed within the perimeter of the frame.

5. The wall hanging music fountain according to the claim 4, wherein the image comprises a front picture and a rear picture.

6. The wall hanging music fountain according to the claim 5, wherein the front picture is mounted onto a lower region of a front region of the mirror frame.

7. The wall hanging music fountain according to the claim 6, wherein the rear picture is mounted on a rear internal wall of the mirror frame.

8. The wall hanging music fountain according to the claim 7, wherein the image is formed from the overlapped regions of the front picture and the rear picture.

9. The wall hanging music fountain according to the claim 1, wherein the mirror frame is sealed.

10. The wall hanging music fountain according to the claim 1, wherein the mirror frame comprises a plurality of side frames disposed within the mirror frame.

11. The wall hanging music fountain according to the claim 1, wherein the water flow distributor comprises a LED wire cavity.

12. The wall hanging music fountain according to the claim 11, wherein a plurality of LED holes are disposed on an upper region of the LED wire cavity.

13. The wall hanging music fountain according to the claim 12, wherein each of said plurality of LED holes is connected with an LED.

14. The wall hanging music fountain according to the claim 1, wherein the controller is suitable for generating water columns of varying heights at varying time intervals.
